(19) United States
(12) Patent Application Publication
(10) Pub. No.: US 2026/0116249 A1
(43) Pub. Date: Apr. 30, 2026

(54) COORDINATED ELECTRIC VEHICLE CHARGE MANAGEMENT SYSTEM

(71) Applicant: FCA US LLC, Auburn Hills, MI (US)

(72) Inventors: Sina Shojaei, Auburn Hills, MI (US); Feisel Weslati, Auburn Hills, MI (US); Kamal Bouyoucef, Auburn Hills, MI (US)

(21) Appl. No.: 18/932,965

(22) Filed: Oct. 31, 2024

(51) Int. Cl. B60L 53/68; B60L 53/62; B60L 53/63; G06Q 30/0251

(52) U.S. Cl. CPC B60L 53/68; B60L 53/62; B60L 53/63; G06Q 30/0266

(57) ABSTRACT

A global charging management system (GCMS) for coordinating charging of one or more electrified vehicles at one or more charging stations includes a computing server configured to communicate with the one or more electrified vehicles and the one or more charging stations via a network. The computing server is configured to receive a travel route from a new customer vehicle that requires charging along the travel route, receive vehicle charging information of the new customer vehicle, identify one or more charging stations along the travel route, receive charging capability information from the one or more charging stations along the travel route, arbitrate the vehicle charging information with the charging capability information, generate a charging service offer at a first charging station for the new customer vehicle, the charging service offer optimized to reduce waiting time and cost, and send the charging service offer to the new customer vehicle.

### FIELD

The present application relates generally to electrified vehicles and, more particularly, to systems and methods to coordinate and manage electrified vehicle charging.

### BACKGROUND

Electrified vehicles (EVs) include at least one electric traction motor powered by a high voltage battery system, which is capable of storing a finite amount of energy. Some electrified vehicles, such as battery electric vehicles (BEVs) and plug-in hybrid electric vehicles (PHEVs), are capable of charging their high voltage battery system using roadside charging stations. However, these roadside charging stations may be few and far between, have high demand overflow, and vary in their charge provision capabilities (power ratings). Thus, while such conventional systems work well for their intended purpose, it is desirable to provide continuous improvement in the relevant art.

### SUMMARY

In accordance with one example aspect of the invention, a global charging management system (GCMS) for coordinating charging of one or more electrified vehicles at one or more charging stations is provided. In one example implementation, the GCMS includes a GCMS computing server configured to communicate with the one or more electrified vehicles and the one or more charging stations via a network. The GCMS computing server is configured to receive a travel route from a new customer vehicle that requires charging of the new customer vehicle along the travel route, receive vehicle charging information of the new customer vehicle, identify one or more charging stations along the travel route, receive charging capability information from the one or more charging stations along the travel route, arbitrate the vehicle charging information with the charging capability information, generate a charging service offer at a first charging station for the new customer vehicle, the charging service offer optimized to reduce waiting time and cost, and send the charging service offer to the new customer vehicle.

In addition to the foregoing, the described GCMS may include one or more of the following features: wherein the GCMS computing server is further configured to determine if the new customer vehicle has accepted the charging service offer, and schedule the charging service offer with the first charging station; wherein if the new customer vehicle declines the charging service offer, the GCMS computing server is further configured to generate an updated charging service offer that offers a reduced charging service, and send the updated charging service offer to the new customer vehicle; and wherein the GCMS computing server is further configured to determine if the new customer vehicle has accepted the updated charging service offer, and schedule the updated charging service offer with the first charging station.

In addition to the foregoing, the described GCMS may include one or more of the following features: wherein if the new customer vehicle declines the updated charging service offer, the GCMS computing server is further configured to generate an incentivized, updated charging service offer that offers cost incentives to accept the incentivized, updated charging service offer, and send the incentivized, updated charging service offer to the new customer vehicle; and wherein the GCMS computing server is further configured to determine if the new customer vehicle has accepted the incentivized, updated charging service offer, and schedule the incentivized, updated charging service offer with the first charging station.

In addition to the foregoing, the described GCMS may include one or more of the following features: wherein if the new customer vehicle declines the incentivized, updated charging service offer, the GCMS computing server is further configured to (i) generate an incentivized, existing charging service offer that offers cost incentives to one or more existing customer vehicles previously scheduled for charging service at the first charging station, which would allow the new customer vehicle charging service offer to be satisfied at the first charging station, and (ii) send the incentivized, existing charging service offer to the one or more existing customer vehicles; and wherein the GCMS computing server is further configured to determine if the one or more existing customer vehicles accept the incentivized, existing charging service offer, and schedule the incentivized, existing charging service offer with the first charging station if the one or more existing customer vehicles accept the incentivized, existing charging service offer.

In addition to the foregoing, the described GCMS may include one or more of the following features: wherein the GCMS computing server is further configured to schedule the charging service offer for the new customer vehicle with the first charging station, if the one or more existing customer vehicles accept the incentivized, existing charging service offer; wherein the GCMS computing server is further configured to (i) predict service limitations at the first charging station, based on the charging capability information, (ii) determine a first updated charging service offer if the service limitations indicate a delay in a start time of the charging service offer, and subsequently send the first updated charging service offer to the new customer vehicle, (iii) determine a second updated charging service offer if the service limitations indicate a reduced charge power, and subsequently send the second updated charging service offer to the new customer vehicle, and (iv) determine a third updated charging service offer if the service limitations indicate a lower charge amount is available than required, and subsequently send the third updated charging service offer to the new customer vehicle.

In addition to the foregoing, the described GCMS may include one or more of the following features: wherein if the first, second, and third updated charging service offers are declined by the new customer, the GCMS computing server is further configured to generate a fourth updated charging service offer at a second charging station along the travel route for the new customer vehicle, and send the fourth updated charging service offer to the new customer vehicle; wherein the vehicle charging information includes a charging time limit, a total charging energy required, and a type of charger, and wherein the charging capability information includes charger availability, a charger waiting time, and a charger type available; and wherein the vehicle charging information is user selected vehicle charging requirements.

In accordance with another example aspect of the invention, a method is provided of coordinating charging of one or more electrified vehicles at one or more charging stations utilizing a global charging management system (GCMS) having a GCMS computing server configured to communicate with the one or more electrified vehicles and the one or more charging stations via a network. In one example implementation, the method includes receiving, by the GCMS computing server, a travel route from a new customer vehicle that requires charging of the new customer vehicle along the travel route; receiving, by the GCMS computing server, vehicle charging information of the new customer vehicle; identifying, by the GCMS computing server, one or more charging stations along the travel route; receiving, by the GCMS computing server, charging capability information from the one or more charging stations along the travel route; arbitrating, by the GCMS computing server, the vehicle charging information with the charging capability information; generating, by the GCMS computing server, a charging service offer at a first charging station for the new customer vehicle, the charging service offer optimized to reduce waiting time and cost; and sending, by the GCMS computing server, the charging service offer to the new customer vehicle.

In addition to the foregoing, the described method may include one or more of the following features: determining, by the GCMS computing server, if the new customer vehicle has accepted or declined the charging service offer; scheduling, by the GCMS computing server, the charging service offer with the first charging station if the new customer vehicle has accepted the charging service offer; and generating and sending to the new customer vehicle, by the GCMS computing server, an updated charging service offer that offers a reduced charging service if the new customer vehicle has declined the charging service offer.

In addition to the foregoing, the described method may include one or more of the following features: determining, by the GCMS computing server, if the new customer vehicle has accepted or declined the updated charging service offer; scheduling, by the GCMS computing server, the updated charging service offer with the first charging station if the new customer vehicle has accepted the updated charging service offer; and generating and sending to the new customer vehicle, by the GCMS computing server, an incentivized, updated charging service offer that offers cost incentives to accept the incentivized, updated charging service offer, if the new customer declines the updated charging service offer.

In addition to the foregoing, the described method may include one or more of the following features: determining, by the GCMS computing server, if the new customer vehicle has accepted or declined the incentivized, updated charging service offer; scheduling, by the GCMS computing server, the incentivized, updated charging service offer with the first charging station if the new customer vehicle has accepted the incentivized, updated charging service offer; and generating and sending, by the GCMS computing server, an incentivized, existing charging service offer that offers cost incentives to one or more existing customer vehicles previously scheduled for charging service at the first charging station, which would allow the new customer vehicle charging service offer to be satisfied at the first charging station, if the new customer vehicle declines the incentivized, updated charging service.

In addition to the foregoing, the described method may include one or more of the following features: determining, by the GCMS computing server, if the one or more existing customer vehicles accept the incentivized, existing charging service offer; and scheduling, by the GCMS computing server, the incentivized, existing charging service offer with the first charging station if the one or more existing customer vehicles accept the incentivized, existing charging service offer; and scheduling, by the GCMS computing server, the charging service offer for the new customer vehicle with the first charging station, if the one or more existing customer vehicles accept the incentivized, existing charging service offer.

In addition to the foregoing, the described method may include one or more of the following features: predicting, by the GCMS computing server, service limitations at the first charging station, based on the charging capability information; determining, by the GCMS computing server, a first updated charging service offer if the service limitations indicate a delay in a start time of the charging service offer, and subsequently sending the first updated charging service offer to the new customer vehicle; determining, by the GCMS computing server, a second updated charging service offer if the service limitations indicate a reduced charge power, and subsequently sending the second updated charging service offer to the new customer vehicle; and determining, by the GCMS computing server, a third updated charging service offer if the service limitations indicate a lower charge amount is available than required, and subsequently sending the third updated charging service offer to the new customer vehicle.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a functional block diagram of an electrified vehicle having an example coordinated EV charge management system in accordance with the principles of the present application;

FIG. 2 is a flow diagram of an example coordinated EV charge management method for a vehicle user, in accordance with the principles of the present application; and

FIGS. 3A-3E illustrate a flow diagram of an example coordinated EV charge management method for a management system in accordance with the principles of the present application.

### DESCRIPTION

As previously described, electrified vehicle (EV) charging at roadside charging stations may be limited due to location, availability, queue, and charging options. Moreover, one hinderance for wide commercialization of EVs is limited access to charging stations. As EV market share increases, the demand for charging stations is expected to surpass the rate of building new stations. Even with more charging stations, charging an EV will likely remain a time-consuming event that may lead to demand overflow. While some OEMs and EV charger suppliers have developed computer applications that allow EV owners to make prior reservations at the charging station of their choice, such applications lack any coordination between multiple vehicles or optimization of the offered charging services.

Accordingly, described herein are systems and methods for coordinated EV charging management. The system, also referred to as a Global Charging Management System (GCMS), is configured to communicate with both customer vehicles and charging station networks to efficiently plan and coordinate charging services. The GCMS includes one or more algorithms configured to communicate in real time with vehicles requesting charging, as well as with the infrastructure of one or more charging stations within a network of connected charging stations.

In one example, the customer vehicles communicate a requested charging service to the GCMS. The GCMS arbitrates all service requests considering active charging services and factors, such as charger type availability and proximity to other charging stations, and offers an optimized charging service to the customer. By doing so, the GCMS will optimize the charging experience for the customer while streamlining the service quality of the network of the charging stations. The algorithms can be hosted centrally on a single computer or distributed between multiple computers or cloud-based systems. Alternatively, portions of the algorithm can be hosted on customer vehicle control units and/or on mobile devices.

In general, the GCMS coordinates different aspects of the charging events of several EVs across one or several charging stations. The GCMS communicates with the EVs requesting charging (customers) and schedules appropriate charging services based on various factors such as the requested service, overall service demand, charger availability, and customer actual charging needs. The GCMS provides confirmation of the scheduled service to the customer vehicles in real-time while also using real-time information from all customer and service stations to optimize and update the scheduled services.

Additionally, the GCMS is configured to arbitrate the services offered to the customers. For example, if the GCMS determines that it cannot meet the service requested by one or more customers (e.g., due to high demand, unavailability of service type, etc.), it can offer alternative services or modify previously scheduled services (active services) to maximize the total number of completed services, minimize total wait time, and reduce service costs.

Additionally, the GCMS is configured to prioritize charging for emergency vehicles (or other vehicle categories) over other customers. Similarly, the GCMS is configured to prioritize emergency minimum charging to vehicles at risk of total shutdown, for example, to enable the customers to maintain vehicle heating while waiting for service in cold ambient.

Further, the GCMS is configured to redirect any number of the requested services to alternative charging stations within the GCMS network to prevent congestion at any particular charging station and to minimize the vehicle stoppage time. In doing so, the GCMS is configured to access information about the onward trips of the customers as well as real-time information from its network of charging stations to make appropriate decisions.

Further still, the GCMS is configured to implement a system of incentives and penalties to persuade the customers to adhere to the offered service schedules. For example, the GCMS can provide incentives to a customer to accept a derated charge service in order to accommodate another customer. Similarly, the GCMS can penalize customers for deviating from schedules service, for example in case of a delayed departure following the completion of service.

Additionally, the GCMS can facilitate journey planning optimization for customers. For customers traveling long distances, the GCMS is configured to calculate a charging service plan that includes consecutive charging services along their trip route. The GCMS optimizes the charging power and charging energy offered to the customer at consecutive charging stations in order to minimize the total trip duration, stoppage duration, and cost.

Accordingly, the system described herein is advantageously configured to (i) optimize the offered charging service based on charger availability, service demand, and customer actual need, (ii) coordinate charging of multiple vehicles at the same time based on minimizing the total waiting times and service costs, (iii) coordinate charging services across multiple charging stations, (iv) implement a system of incentives for accepting alternative charging service offers, (v) implement a system of penalties for deviation from scheduled services, and (vi) optimize and schedule consecutive services along a customer's route based on minimization of total trip time and cost.

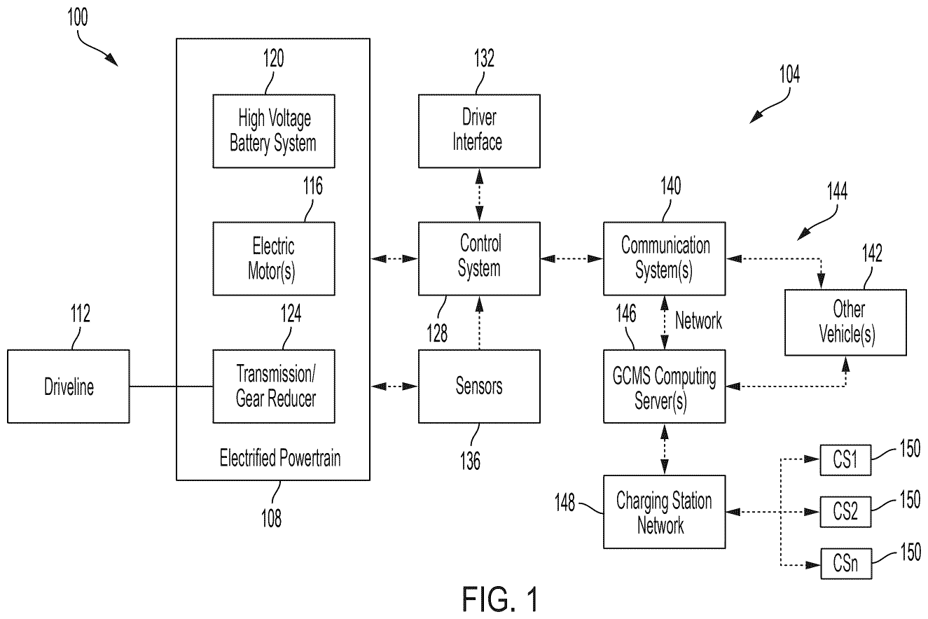

Referring now to FIG. 1, a functional block diagram of an electrified vehicle 100 configured to operate/interface with an example Global Charging Management System (GCMS) 104 according to the principles of the present application is illustrated. The electrified vehicle 100 includes an electrified powertrain 108 configured to generate and transfer torque to a driveline 112 for propulsion. The electrified powertrain 108 includes at least one electric motor 116 (e.g., a three-phase electric traction motor) powered by a high voltage battery pack or system 120. The electrified powertrain 108 also includes a transmission or gear reducer 124 configured to transfer the drive torque from the electric motor(s) 116 to the driveline 112. While an electric-only configuration of the electrified vehicle 100 (a battery electric vehicle, or BEV) is illustrated, it will be appreciated that the electrified powertrain 108 could further include another energy generator, such as an internal combustion engine (a hybrid electric vehicle, or HEV) and/or a hydrogen or other suitable fuel cell system (a fuel cell electric vehicle, or FCEV).

A control system 128 controls operation of the electrified vehicle 100, which primarily includes controlling the electrified powertrain 108 to generate a desired amount of drive torque to satisfy a driver torque request provided via a driver interface 132 (e.g., an accelerator pedal). A plurality of sensors 136 are configured to measure operating parameters of the electrified vehicle 100, such as, but not limited to, speeds/accelerations, pressures, temperatures, and electrical parameters (voltage, current, state of charge, etc.). The sensors 136 also include other vehicle systems, such as a navigation/maps system.

The control system 128 is also configured to communicate with other devices/systems (e.g., other vehicles 142) using one or more communication systems 140 each configured for communication via a particular communication network or medium 144. For example, the communication systems 140 could include a long-range cellular communication transceiver, a short-range wireless communication (e.g., Bluetooth) transceiver. The network 144 can be any suitable communication network including, for example, a satellite network, a cellular network (3G, 4G LTE, 5G, etc.), a computing network (local area network, the internet, etc.), or some combination thereof.

One particular communication by the control system 128 via the communication system(s) 140 is with a set of one or more GCMS computing servers 146 that store/analyze data provided by the plurality of vehicles 100, 142. The GCMS computing servers 146 are in communication with a charging station network 148 that includes one or more individual charging stations 150. The GCMS computing servers 146 may be owned and operated by a particular vehicle original equipment manufacturer (OEM) or other entity and may only be accessible to authorized users, such as through a computer application.

In some implementations, the coordinated vehicle charging management and trip planning/optimization are performed by the GCMS computing servers 146, which may be a cloud-based system. The GCMS algorithm(s) may be run on the cloud-based system wherein it will have direct access to vehicle data (e.g., trip navigation) and user charging/service requests. The cloud-based GCMS computing servers 146 can have substantial computing resources for execution of the GCMS algorithm(s).

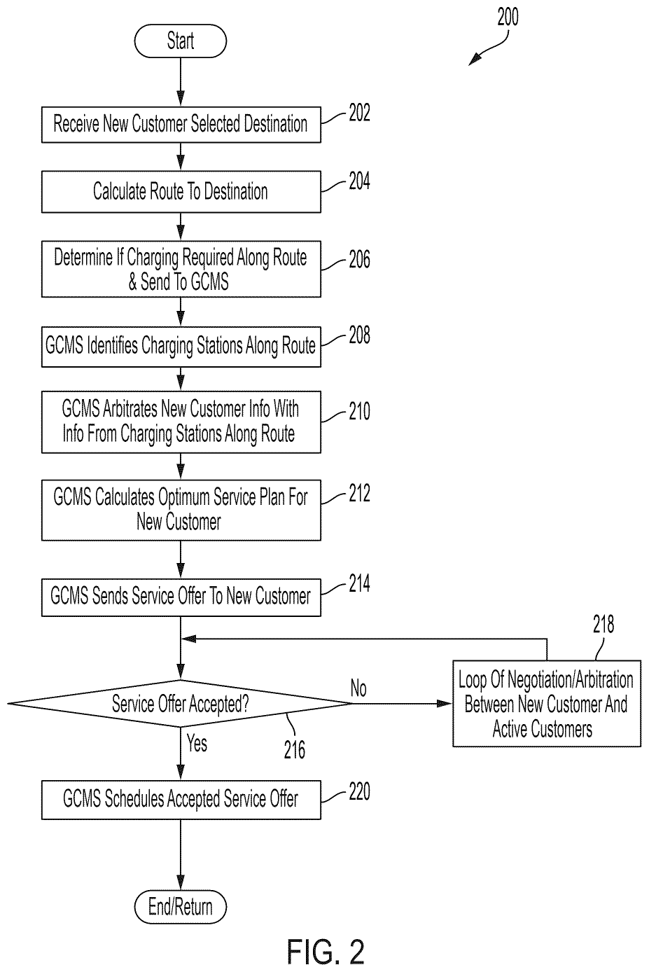

Referring now to FIG. 2, a flow diagram of an example vehicle charging coordination method 200 of the GCMS 104 for an electrified vehicle according to the principles of the present application is illustrated. While the method 200 specifically references the electrified vehicle 100 and its components for illustrative/descriptive purposes, it will be appreciated that the method 200 could be applicable to any suitably configured electrified vehicle.

In the example embodiment, the method 200 begins at 202 and control system 128 (“control”) receives input where a new customer (e.g., driver) selects a destination on a navigation system or other journey planner. At 204, the navigation system and/or control system 128 calculates an approximate route for the destination. At 206, control determines if the vehicle 100 will require charging along the route in order to reach the destination, and sends this information to the GCMS 104.

At 208, the GCMS 104 (e.g., GCMS computing servers 146) identify charging stations along the route of the new customer. At 210, the GCMS 104 arbitrates information from the new customer with information from the charging stations identified along the new customer's route. Example customer information may include requested service, vehicle status (e.g., location, remaining state of charge, trip plan), etc. Example charging station information may include location, available charger types, active service scheduled, etc. However, it will be appreciated that such customer/station information may include any relevant information that enables the GCMS 104 to function as described herein.

At 212, the GCMS 104 calculates an optimum service plan (service offer) for the new customer to satisfy user selected/identified service requests, based on factors such as trip duration, cost minimization, etc. Example user selected/identified service requests include charging time, total charging energy, and charger type. At 214, the GCMS 104 sends the service offer to the new customer.

At 216, the GCMS 104 determines if the new customer accepts the offer. If no, at 218, the GCMS 104 arbitrates between the new customer and active customers to provide a new service offer and returns to 216. If the new customer accepts the offer, at 220, the GCMS 104 schedules the service offer at the selected charging station 150. The method 200 then ends or returns to 202.

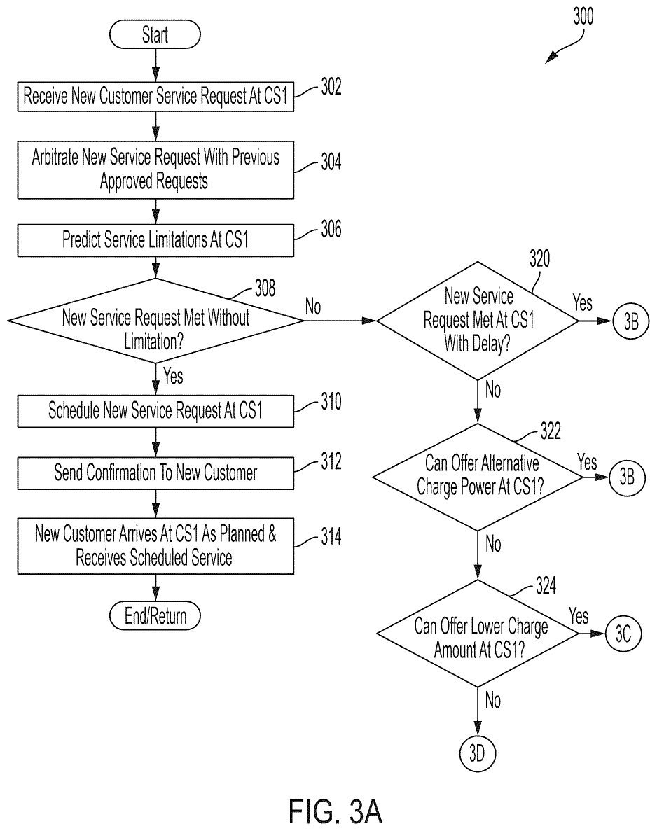

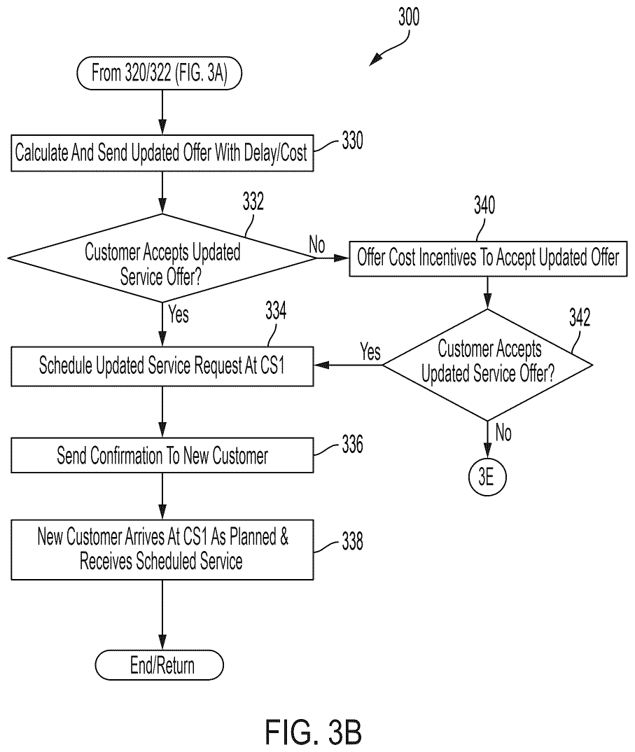

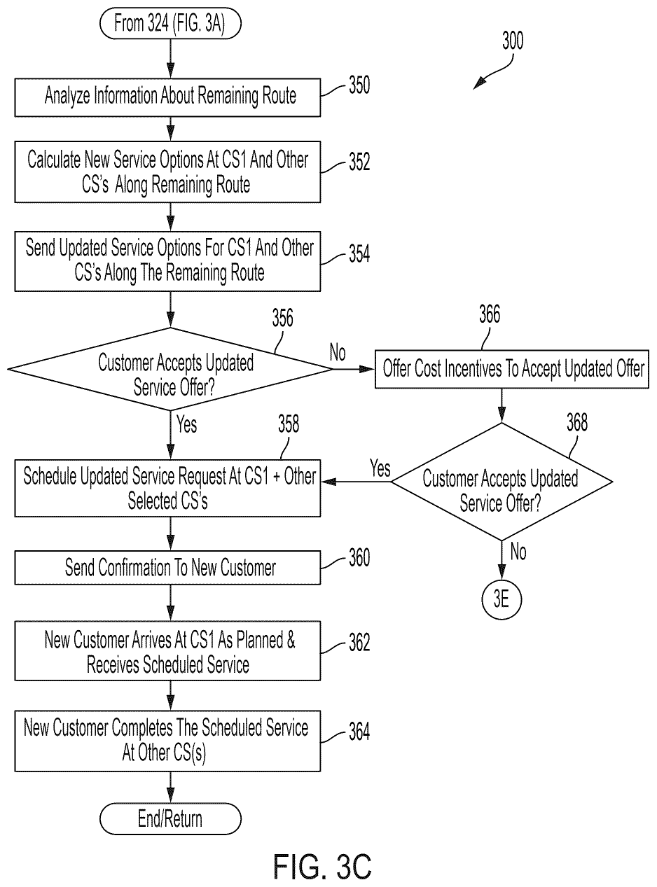

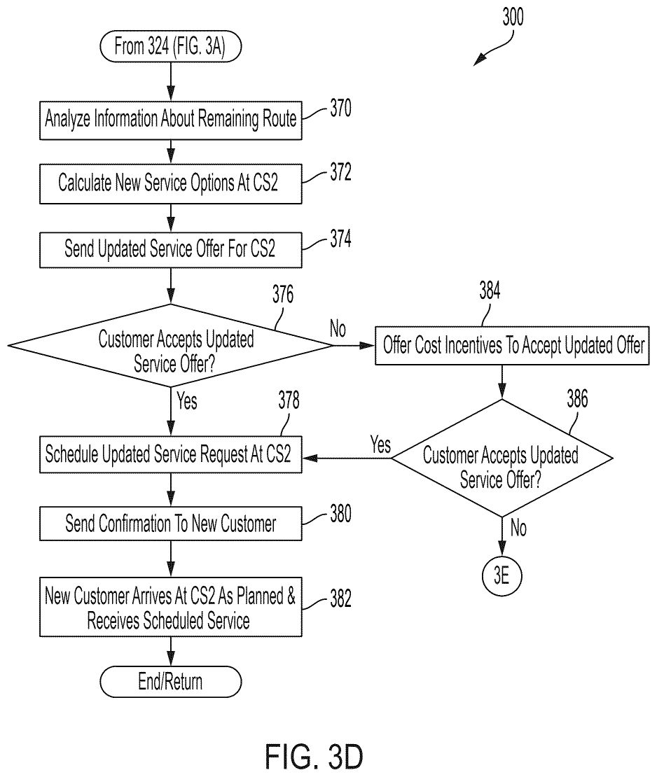

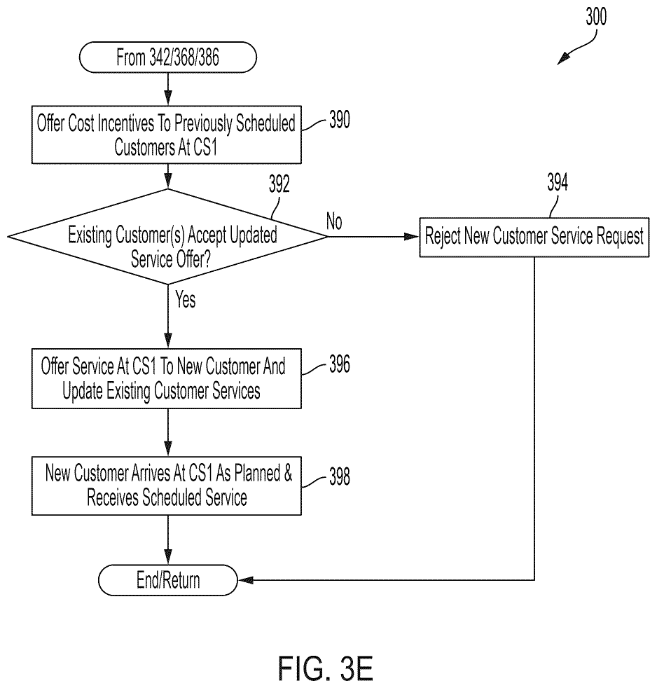

Referring now to FIGS. 3A-3E, a flow diagram of an example vehicle charging coordination method 300 of the GCMS 104 for an electrified vehicle according to the principles of the present application is illustrated. The method 300 begins at 302 where the GCMS 104 receives (e.g., from vehicle 100) a new customer service request at a first charging station 150 (CS1). At 304, GCMS 104 arbitrates the new request with previously approved requests at CS1 and real-time network data (e.g., location, available charger types, active service schedules, etc.). At 306, GCMS 104 determines/predicts any limitation of service for the new customer at CS1. At 308, GCMS 104 determines if the new service request can be met without limitation at CS1. If yes, the method proceeds to 310. If no, the method proceeds to 320.

At 310, if the new service request can be met without limitation, the GCMS 104 schedules the new customer for the requested service at CS1. At 312, GCMS 104 sends a confirmation to the new customer (vehicle 100). At 314, the new customer vehicle arrives at CS1 as planned and receives the scheduled service. The method then ends or returns to 302.

At 320, if the new service request cannot be met without limitation, the GCMS 104 determines if the service request at CS1 can be met with a delay. For example, the GCMS 104 determines if there is a queue that could delay charging. If yes, the method proceeds to FIG. 3B. If no, at 322, the GCMS 104 determines if an alternative charge power can be offered at CS1. For example, the GCMS 104 determines if a standard charger is available as opposed to a requested super charger. If yes, the method proceeds to FIG. 3B. If no, at 324, the GCMS 104 determines if a lower charge amount can be offered at CS1. For example, the GCMS 104 determines if a 40% battery charge can be provided as opposed to a requested 80% battery charge. If yes, the method proceeds to FIG. 3C. If no, the method proceeds to FIG. 3D.

Turning now to FIG. 3B, the method proceeds to 330 if the new service request can be met at CS1 without a delay (step 320) or if an alternative charge power can be provided at CS1 (step 322). At 330, the GCMS 104 calculates the estimated cost and stoppage time/time to charge, and then sends an updated service offer to the new customer. At 332, the GCMS 104 determines if the new customer accepts the service offer. If yes, the method proceeds to 334. If no, the method proceeds to 340. At 334, the GCMS 104 schedules the new customer for the updated service at CS1. At 336, GCMS 104 sends a confirmation to the new customer. At 338, the new customer arrives at CS1 as planned and receives the scheduled updated service. The method then ends or returns to 302.

At 340, if the updated offer is declined, the GCMS 104 offers cost incentives to the new customer for accepting the offered service (if (possible/available). Example incentives include, but are not limited to, reduced charging rate on the current or future charge, a credit, line skipping, etc. At 342, the GCMS 104 determines if the new customer accepts the incentivized, updated service offer. If yes, the method proceeds to 334. If no, the method proceeds to FIG. 3E.

Turning now to FIG. 3C, the method proceeds to 350 if a lowered charge amount can be provided at CS1 (step 324). At 350, the GCMS 104 receives and analyzes information about the new customer remaining route. At 352, the GCMS 104 calculates new service options at CS1 as well as one or more other charging stations 150 along the trip route of the new customer. At 354, the GCMS 104 sends an updated service offer to the new customer that includes charging services at CS1 supplemented by the one or more additional charging stations 150.

At 356, the GCMS 104 determines if the new customer accepts the updated service offer. If yes, the method proceeds to 358. If no, the method proceeds to 366. At 358, the GCMS 104 schedules the new customer for the updated service at all charging stations selected by the new customer (e.g., CS1 and one or more additional charging stations 150). At 360, GCMS 104 sends a confirmation to the new customer. At 362, the new customer arrives at CS1 as planned and receives the scheduled updated service. At 364, the new customer arrives at the one or more additional charging stations 150 and completes the scheduled services. The method then ends or returns to 302.

Returning to 366, if the updated offer is declined, the GCMS 104 offers cost incentives to the new customer for accepting the offered service (if possible/available). At 368, the GCMS 104 determines if the new customer accepts the incentivized, updated service offer. If yes, the method proceeds to 358. If no, the method proceeds to FIG. 3E.

Turning now to FIG. 3D, the method proceeds to 370 if a lowered charge amount cannot be provided at CS1 (step 324). At 370, the GCMS 104 receives and analyzes information about the new customer remaining route. At 372, the GCMS 104 calculates new service options (to fulfill the previous requested service) at an additional charging station (CS2) along the remaining trip route. At 374, the GCMS 104 sends an updated service offer to the new customer that includes charging services at CS2. At 376, the GCMS 104 determines if the new customer accepts the updated service offer. If yes, the method proceeds to 378. If no, the method proceeds to 384. At 378, the GCMS 104 schedules the new customer for the updated service at CS2. At 380, GCMS 104 sends a confirmation to the new customer. At 382, the new customer arrives at CS2 as planned and receives the scheduled updated service. The method then ends or returns to 302.

At 384, if the updated offer is declined, the GCMS 104 offers cost incentives to the new customer for accepting the offered service (if possible/available). At 386, the GCMS 104 determines if the new customer accepts the incentivized, updated service offer. If yes, the method proceeds to 378. If no, the method proceeds to FIG. 3E.

Turning now to FIG. 3E, the method proceeds to 390 if the updated service offer is declined by the new user (step 342, 368, 386). At 390, the GCMS 104 sends and offers cost incentives to previously scheduled customers at CS1 to accept alternative services to free up service for the new customer. Example alternative services may include, but are not limited to, a delayed charging start time, a reduced charging time, a reduced total charging energy, a different charger type, etc. At 392, the GCMS 104 determines if an existing customer accepts the alternative service. If no, at 394, the GCMS 104 rejects the new customer service request and the method ends or returns to 302. If yes, at 396, the GCMS 104 offers the requested service at CS1 to the new customer, and amends the previously scheduled services of the existing customer(s) that accepted the alternative service. At 398, all customers arrive at CS1 as per their respective service plans and receive their scheduled services. The method then ends or returns to 302.

Described herein are systems and methods for a global charging management system (GCMS) configured to schedule electrified vehicle charging sessions by coordinating between multiple vehicles and charging stations. The system is configured to optimize the location and type of charging service offered to customers while enhancing trip planning capability of customers by scheduling consecutive optimized charging services along their onward trip route.

In one example, the GCMS refers to an intelligent system of planning and coordinating the charging service of multiple electrified vehicles at one or more charging stations. Service refers to a time of charging, total charging energy (kWh energy), and charger type (fast, superfast, etc.). Service request refers to a charging service requested by the customer (driver) in the first instance of communication with the GCMS. Offered service refers to a charging service offered to the customer by the GCMS based on optimization of various factors and coordination amongst all customers. Service type refers to the power of the charger (e.g., fast charger, super charger, etc.). Active service refers to a charging service that has already been scheduled and confirmed by the customer, either ongoing or due to start in the future. New customer refers to a vehicle that sends a new service request to the GCMS.

It will be appreciated that the term “controller” or “module” or “computing server/device” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

1. A global charging management system (GCMS) for coordinating charging of one or more electrified vehicles at one or more charging stations, the GCMS comprising:
a GCMS computing server configured to communicate with the one or more electrified vehicles and the one or more charging stations via a network, wherein the GCMS computing server includes one or more processors and a non-transitory memory having a plurality of instructions stored thereon, which when executed by the one or more processors, cause the one or more processors to perform operations comprising:
receive, by the GCMS computing server, a travel route from a navigation system of a new customer vehicle that requires charging of the new customer vehicle along the travel route;
receive, from the navigation system and at the GCMS computing server, user-selected vehicle charging information of the new customer vehicle;
identify, by the GCMS computing server, one or more charging stations along the travel route;
receive, at the GCMS computing server, charging capability information from the one or more charging stations along the travel route;
arbitrate, by the GCMS computing server, the user-selected vehicle charging information with the charging capability information;
generate, by the GCMS computing server and based on the arbitrated user-selected charging information and charging capability information, a charging service offer at a first charging station for the new customer vehicle, the charging service offer optimized to reduce waiting time and cost; and
send, by the GCMS computing server, the charging service offer to the navigation system of the new customer vehicle.

2. The GCMS of claim 1, wherein the GCMS computing server is further configured to:
determine if the new customer vehicle has accepted the charging service offer; and
schedule the charging service offer with the first charging station.

3. The GCMS of claim 2, wherein if the new customer vehicle declines the charging service offer, the GCMS computing server is further configured to:
generate an updated charging service offer that offers a reduced charging service; and
send the updated charging service offer to the new customer vehicle.

4. The GCMS of claim 3, wherein the GCMS computing server is further configured to:
determine if the new customer vehicle has accepted the updated charging service offer; and
schedule the updated charging service offer with the first charging station.

5. The GCMS of claim 4, wherein if the new customer vehicle declines the updated charging service offer, the GCMS computing server is further configured to:
generate an incentivized, updated charging service offer that offers cost incentives to accept the incentivized, updated charging service offer; and
send the incentivized, updated charging service offer to the new customer vehicle.

6. The GCMS of claim 5, wherein the GCMS computing server is further configured to:
determine if the new customer vehicle has accepted the incentivized, updated charging service offer; and
schedule the incentivized, updated charging service offer with the first charging station.

7. The GCMS of claim 6, wherein if the new customer vehicle declines the incentivized, updated charging service offer, the GCMS computing server is further configured to:
generate an incentivized, existing charging service offer that offers cost incentives to one or more existing customer vehicles previously scheduled for charging service at the first charging station, which would allow the new customer vehicle charging service offer to be satisfied at the first charging station; and
send the incentivized, existing charging service offer to the one or more existing customer vehicles.

8. The GCMS of claim 7, wherein the GCMS computing server is further configured to:
determine if the one or more existing customer vehicles accept the incentivized, existing charging service offer; and
schedule the incentivized, existing charging service offer with the first charging station if the one or more existing customer vehicles accept the incentivized, existing charging service offer.

9. The GCMS of claim 8, wherein the GCMS computing server is further configured to:
schedule the charging service offer for the new customer vehicle with the first charging station, if the one or more existing customer vehicles accept the incentivized, existing charging service offer.

10. The GCMS of claim 1, wherein the GCMS computing server is further configured to:
predict service limitations at the first charging station, based on the charging capability information;
determine a first updated charging service offer if the service limitations indicate a delay in a start time of the charging service offer, and subsequently send the first updated charging service offer to the new customer vehicle;
determine a second updated charging service offer if the service limitations indicate a reduced charge power, and subsequently send the second updated charging service offer to the new customer vehicle; and
determine a third updated charging service offer if the service limitations indicate a lower charge amount is available than required, and subsequently send the third updated charging service offer to the new customer vehicle.

11. The GCMS of claim 10, wherein if the first, second, and third updated charging service offers are declined by the new customer, the GCMS computing server is further configured to:
generate a fourth updated charging service offer at a second charging station along the travel route for the new customer vehicle; and
send the fourth updated charging service offer to the new customer vehicle.

12. The GCMS of claim 1, wherein the vehicle charging information includes a charging time limit, a total charging energy required, and a type of charger, and
wherein the charging capability information includes charger availability, a charger waiting time, and a charger type available.

13. The GCMS of claim 1, wherein the vehicle charging information is user selected vehicle charging requirements.

14. A method of coordinating charging of one or more electrified vehicles at one or more charging stations utilizing a global charging management system (GCMS) having a GCMS computing server with one or more processors and a non-transitory memory, the GCMS configured to communicate with the one or more electrified vehicles and the one or more charging stations via a network, the method comprising:
receiving, by the GCMS computing server, a travel route from a navigation system of a new customer vehicle that requires charging of the new customer vehicle along the travel route;
receiving, from the navigation system and by the GCMS computing server, user-selected vehicle charging information of the new customer vehicle;
identifying, by the GCMS computing server, one or more charging stations along the travel route;
receiving, by the GCMS computing server, charging capability information from the one or more charging stations along the travel route;
arbitrating, by the GCMS computing server, the user-selected vehicle charging information with the charging capability information;
generating, by the GCMS computing server and based on the arbitrated user-selected charging information and charging capability information, a charging service offer at a first charging station for the new customer vehicle, the charging service offer optimized to reduce waiting time and cost; and
sending, by the GCMS computing server, the charging service offer to the navigation system of the new customer vehicle.

15. The method of claim 14, further comprising:
determining, by the GCMS computing server, if the new customer vehicle has accepted or declined the charging service offer;
scheduling, by the GCMS computing server, the charging service offer with the first charging station if the new customer vehicle has accepted the charging service offer; and
generating and sending to the new customer vehicle, by the GCMS computing server, an updated charging service offer that offers a reduced charging service if the new customer vehicle has declined the charging service offer.

16. The method of claim 15, further comprising:
determining, by the GCMS computing server, if the new customer vehicle has accepted or declined the updated charging service offer;
scheduling, by the GCMS computing server, the updated charging service offer with the first charging station if the new customer vehicle has accepted the updated charging service offer; and
generating and sending to the new customer vehicle, by the GCMS computing server, an incentivized, updated charging service offer that offers cost incentives to accept the incentivized, updated charging service offer, if the new customer declines the updated charging service offer.

17. The method of claim 16, further comprising:
determining, by the GCMS computing server, if the new customer vehicle has accepted or declined the incentivized, updated charging service offer;
scheduling, by the GCMS computing server, the incentivized, updated charging service offer with the first charging station if the new customer vehicle has accepted the incentivized, updated charging service offer; and
generating and sending, by the GCMS computing server, an incentivized, existing charging service offer that offers cost incentives to one or more existing customer vehicles previously scheduled for charging service at the first charging station, which would allow the new customer vehicle charging service offer to be satisfied at the first charging station, if the new customer vehicle declines the incentivized, updated charging service.

18. The method of claim 17, further comprising:
determining, by the GCMS computing server, if the one or more existing customer vehicles accept the incentivized, existing charging service offer; and
scheduling, by the GCMS computing server, the incentivized, existing charging service offer with the first charging station if the one or more existing customer vehicles accept the incentivized, existing charging service offer.

19. The method of claim 18, further comprising:
scheduling, by the GCMS computing server, the charging service offer for the new customer vehicle with the first charging station, if the one or more existing customer vehicles accept the incentivized, existing charging service offer.

20. The method of claim 14, further comprising:
predicting, by the GCMS computing server, service limitations at the first charging station, based on the charging capability information;
determining, by the GCMS computing server, a first updated charging service offer if the service limitations indicate a delay in a start time of the charging service offer, and subsequently sending the first updated charging service offer to the new customer vehicle;
determining, by the GCMS computing server, a second updated charging service offer if the service limitations indicate a reduced charge power, and subsequently sending the second updated charging service offer to the new customer vehicle; and
determining, by the GCMS computing server, a third updated charging service offer if the service limitations indicate a lower charge amount is available than required, and subsequently sending the third updated charging service offer to the new customer vehicle.
